(19) United States
(12) Patent Application Publication
(10) Pub. No.: US 2014/0158061 A1
(43) Pub. Date: Jun. 12, 2014

(54) APPARATUS AND METHOD FOR ATTRACTING FISH

(71) Applicant: DAVID BEASLEY, WOODFORD, VA (US)

(72) Inventor: DAVID BEASLEY, WOODFORD, VA (US)

(21) Appl. No.: 14/095,970

(22) Filed: Dec. 3, 2013

Related U.S. Application Data
(60) Provisional application No. 61/735,512, filed on Dec. 10, 2012.

(51) Int. Cl. A01K 61/00

(52) U.S. Cl. CPC A01K 61/006
USPC 119/221

(57) ABSTRACT

An apparatus for attracting fish comprises a center hub and a plurality of limbs each having a proximal end comprising an attachment mechanism and a distal end. Each limb is pivotably affixed to the center hub at its proximal end via the attachment mechanism. Each of the plurality of limbs depends downward from the center hub in a respective undeployed position when the apparatus is upright but not deployed in water. The distal end of each of the plurality of limbs floats is configured to float upward such that each of the plurality of limbs pivots into a respective deployed position when the apparatus is submerged in water. At least a portion of the attachment mechanism of each of the plurality of limbs moves up and down within a respective vertical channel defined in the center hub as the respective limb moves between its undeployed position and its deployed position.

### CROSS-REFERENCE TO RELATED APPLICATIONS

This application claims priority to U.S. Provisional Application Ser. No. 61/735,512, filed Dec. 10, 2012, the contents of which are incorporated herein by reference in its entirety.

### BACKGROUND

Fish in bodies of water (such as lakes, ponds, rivers, oceans, etc.) often prefer to congregate near and around physical structures, such as underwater vegetation, fallen trees, natural and artificial reefs, etc. Some types of fish use these structures for protection, because the fish can hide behind parts of the structure and within the shadows cast by parts of the structure. Other types of fish use these structures as a hunting ground, because many types of prey fish congregate around these structures. Fisherman also like to fish near these structures, again because many types of fish congregate around these structures.

Many bodies of water lack any or sufficient underwater structures to attract fish. This lack or insufficiency may be seasonal, as underwater vegetation may die or go dormant during winters. Or the lack or insufficiency may simply be an inherent feature of a particular body of water. It is known to add man-made structures to bodies of water for the purpose of attracting fish. Many different types of physical objects are placed underwater to establish artificial reefs. However, such man-made structures are generally permanent, and are certainly not portable enough to be carried around and deployed on an ad hoc basis, for example for use on by a lone fisherman during a particular fishing trip. Also, such man-made structures are not deployable through an ice fishing hole.

### BRIEF SUMMARY

In one embodiment of the invention, an apparatus for attracting fish comprises a central hub and a plurality of arms. Each arm has a proximal end comprising an attachment mechanism and a distal end, and each arm is pivotably affixed to the central hub at its proximal end via the attachment mechanism. Each of the plurality of arms depend downward from the central hub in a respective undeployed position when the apparatus is upright but not deployed in water. The distal end of each of the plurality of arms is configured to float upward such that each of the plurality of arms pivots into a respective deployed position when the apparatus is submerged in water. At least a portion of the attachment mechanism of each of the plurality of arms moves up and down within a respective vertical channel defined in the central hub as the respective arm moves between its undeployed position and its deployed position.

Each of the plurality of arms may be affixed to the central hub at a same level as each other of the plurality of arms.

The plurality of arms may be evenly spaced about a periphery of the central hub.

Each of the plurality of arms may be either constructed of a buoyant material or has buoyant material attached thereto or both.

At least two different ones of the plurality of arms may be at different angles relative to a longitudinal axis of the central hub when in their respective deployed positions.

Each of the plurality of arms may belong to one of two or more groups of arms. All arms within a same group may be at a same angle relative to a longitudinal axis of the central hub when in their respective deployed positions. All arms within a same group may be at a different angle relative to the longitudinal axis of the central hub when in their respective deployed positions than all arms in the other group or groups when in their respective deployed positions.

A pivot finger may extend perpendicularly from the attachment mechanism of each of the plurality of arms; and wherein the pivot finger of each of the plurality of arms rotates within a respective horizontal cavity defined in the central hub as the respective arm moves between its undeployed position and its deployed position.

Each attachment mechanism may comprise a projection that contacts a portion of the central hub when the respective arm is in its respective deployed position to thereby prevent the respective arm from pivoting upward beyond its respective deployed position.

Each attachment mechanism may comprise a projection that controls an angle of each respective arm relative to a longitudinal axis of the central hub when the respective arm is in its respective deployed position.

A mating interface between each of the plurality of arms and the central hub may control an angle of each respective arm relative to a longitudinal axis of the central hub when the respective arm is in its respective deployed position.

Each of the plurality of arms may depend downward and outward from the central hub in its respective undeployed position such that all of the arms flare outward from a longitudinal axis of the central hub when the apparatus is upright but not deployed in water. Each attachment mechanism may comprise a projection that controls an angle of each respective arm relative to the longitudinal axis of the central hub when the respective arm is in its respective undeployed position. Each of the plurality of arms may flare outward from the longitudinal axis of the central hub at an angle of three to ten degrees when the apparatus is upright but not deployed in water.

Either the apparatus may comprise a weight affixed to the central hub or the central hub may be negatively buoyant such that the entire apparatus is either neutrally buoyant or negatively buoyant.

In an alternative embodiment of the invention, a method of attracting fish comprises submerging a fish attracting apparatus in a body of water. The fish attracting apparatus comprises a central hub and a plurality of arms. Each arm has a proximal end comprising an attachment mechanism and a distal end. Each arm is pivotably affixed to the central hub at its proximal end via the attachment mechanism. Each of the plurality of arms depend downward from the central hub in a respective undeployed position when the apparatus is upright but not deployed in water. The distal end of each of the plurality of arms is configured to float upward such that each of the plurality of arms pivots into a respective deployed position when the apparatus is submerged in water. At least a portion of the attachment mechanism of each of the plurality of arms moves up and down within a respective vertical channel defined in the central hub as the respective arm moves between its undeployed position and its deployed position.

Each of the plurality of arms may be affixed to the central hub at a same level as each other of the plurality of arms.

The plurality of arms may be evenly spaced about a periphery of the central hub.

Each of the plurality of arms may be either constructed of a buoyant material or may have buoyant material attached thereto or both.

At least two different ones of the plurality of arms may be at different angles relative to a longitudinal axis of the central hub when in their respective deployed positions.

Each of the plurality of arms may belong to one of two or more groups of arms. All arms within a same group may be at a same angle relative to a longitudinal axis of the central hub when in their respective deployed positions. All arms within a same group may be at a different angle relative to the longitudinal axis of the central hub when in their respective deployed positions than all arms in the other group or groups when in their respective deployed positions.

A pivot finger may extend perpendicularly from the attachment mechanism of each of the plurality of arms. The pivot finger of each of the plurality of arms may rotate within a respective horizontal cavity defined in the central hub as the respective arm moves between its undeployed position and its deployed position.

Each attachment mechanism may comprise a projection that contacts a portion of the central hub when the respective arm is in its respective deployed position to thereby prevent the respective arm from pivoting upward beyond its respective deployed position.

Each attachment mechanism may comprise a projection that controls an angle of each respective arm relative to a longitudinal axis of the central hub when the respective arm is in its respective deployed position.

A mating interface between each of the plurality of arms and the central hub may control an angle of each respective arm relative to a longitudinal axis of the central hub when the respective arm is in its respective deployed position.

Each of the plurality of arms may depend downward and outward from the central hub in its respective undeployed position such that all of the arms flare outward from a longitudinal axis of the central hub when the apparatus is upright but not deployed in water. Each attachment mechanism may comprise a projection that controls an angle of each respective arm relative to the longitudinal axis of the central hub when the respective arm is in its respective undeployed position. Each of the plurality of arms may flare outward from the longitudinal axis of the central hub at an angle of three to ten degrees when the apparatus is upright but not deployed in water.

Either the apparatus may comprise a weight affixed to the central hub or the central hub may be negatively buoyant such that the entire apparatus is either neutrally buoyant or negatively buoyant.

The method may further comprise creating a hole in ice covering at least a portion of the body of water and inserting the fish attracting apparatus through the created hole and into the body of water.

In an alternative embodiment of the invention, an apparatus for attracting fish comprises a central hub and a plurality of arms each having a proximal end and a distal end and each being pivotably affixed to the central hub at its proximal end. Each of the plurality of arms depend downward and outward from the central hub in a respective undeployed position when the apparatus is upright but not deployed in water such that all of the arms flare outward from a longitudinal axis of the central hub when the apparatus is upright but not deployed in water. The distal end of each of the plurality of arms is configured to float upward such that each of the plurality of arms pivots into a respective deployed position when the apparatus is submerged in water.

Each of the plurality of arms may be affixed to the central hub at a same level as each other of the plurality of arms.

The plurality of arms may be evenly spaced about a periphery of the central hub.

Each of the plurality of arms may be either constructed of a buoyant material or may have buoyant material attached thereto or both.

At least two different ones of the plurality of arms may be at different angles relative to a longitudinal axis of the central hub when in their respective deployed positions.

Each of the plurality of arms may belong to one of two or more groups of arms. All arms within a same group may be at a same angle relative to a longitudinal axis of the central hub when in their respective deployed positions. All arms within a same group may be at a different angle relative to the longitudinal axis of the central hub when in their respective deployed positions than all arms in the other group or groups when in their respective deployed positions.

The proximal end of each of the plurality of arms may comprise an attachment mechanism. At least a portion of the attachment mechanism of each of the plurality of arms may move up and down within a respective vertical channel defined in the central hub as the respective arm moves between its undeployed position and its deployed position. A pivot finger may extend perpendicularly from the attachment mechanism of each of the plurality of arm. The pivot finger of each of the plurality of arms may rotate within a respective horizontal cavity defined in the central hub as the respective arm moves between its undeployed position and its deployed position.

Each attachment mechanism may comprise a projection that contacts a portion of the central hub when the respective arm is in its respective deployed position to thereby prevent the respective arm from pivoting upward beyond its respective deployed position.

Each attachment mechanism may comprise a projection that controls an angle of each respective arm relative to a longitudinal axis of the central hub when the respective arm is in its respective deployed position.

Each attachment mechanism may comprise a projection that controls an angle of each respective arm relative to the longitudinal axis of the central hub when the respective arm is in its respective undeployed position.

Each of the plurality of arms may flare outward from the longitudinal axis of the central hub at an angle of three to ten degrees when the apparatus is upright but not deployed in water.

A mating interface between each of the plurality of arms and the central hub may control an angle of each respective arm relative to a longitudinal axis of the central hub when the respective arm is in its respective deployed position.

Either the apparatus may comprise a weight affixed to the central hub or the central hub may be negatively buoyant such that the entire apparatus is either neutrally buoyant or negatively buoyant.

In addition to the apparatus for attracting fish, as described above, other aspects of the present invention are directed to corresponding methods for apparatus of attracting fish.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a side view of an apparatus for attracting fish in an open/deployed configuration, in accordance with an embodiment of the invention.

FIG. 2(A) is a side view of the apparatus of FIG. 1 in a closed/undeployed configuration.

FIG. 3 is a perspective view of one limb or arm of the apparatus of FIG. 1.

FIG. 4 is a close up perspective view of the proximal end of the limb of FIG. 3.

FIGS. 5 and 6 are, respectively, top and bottom perspective views of a center hub of the apparatus of FIG. 1.

FIG. 7 is a top perspective view of a bottom portion of the center hub of the apparatus of FIG. 1, with no limbs attached.

FIG. 8 is a bottom perspective view of a top portion of the center hub of the apparatus of FIG. 1, with no limbs attached.

FIG. 9 is a top perspective view of the bottom portion of the center hub of the apparatus of FIG. 1, with limbs attached (shown truncated).

FIGS. 10A-10C are close up side views of the proximal ends of three alternative limbs of the apparatus of FIG. 1.

FIG. 11 is a cross-sectional view of the center hub of the apparatus of FIG. 1, with no limbs attached.

FIG. 12 is a cross-sectional view of the center hub of the apparatus of FIG. 1, with the attached limb (shown truncated) in an undeployed position.

FIGS. 13-15 are cross-sectional views of the center hub of the apparatus of FIG. 1, each showing the attached limb (shown truncated) deployed at a different angle.

FIG. 16 is a bottom perspective view of the center hub of the apparatus of FIG. 1, with optional weights attached.

FIG. 17 is a perspective view of one limb or arm of an apparatus for attracting fish, in accordance with alternative embodiments of the invention.

FIG. 18 is a close up perspective view of the proximal end of the limb of FIG. 17.

FIG. 19 is a cross-sectional view of a center hub of an apparatus for attracting fish, with no limbs attached, in accordance with alternative embodiments of the invention.

FIGS. 20-22 are cross-sectional views of the center hub of FIG. 19, each showing the attached limbs (shown truncated) deployed at a different angle.

FIG. 23 is a side view of an apparatus for attracting fish in an open/deployed configuration, in accordance with an alternative embodiment of the invention.

### DETAILED DESCRIPTION

Embodiments of the invention comprise devices and methods for attracting fish. Such a device may comprise an underwater structure in which a plurality of limbs or arms is affixed to a center hub. The limbs are hingedly or pivotably affixed. When deployed, the limbs project from the hub at a plurality of different angles.

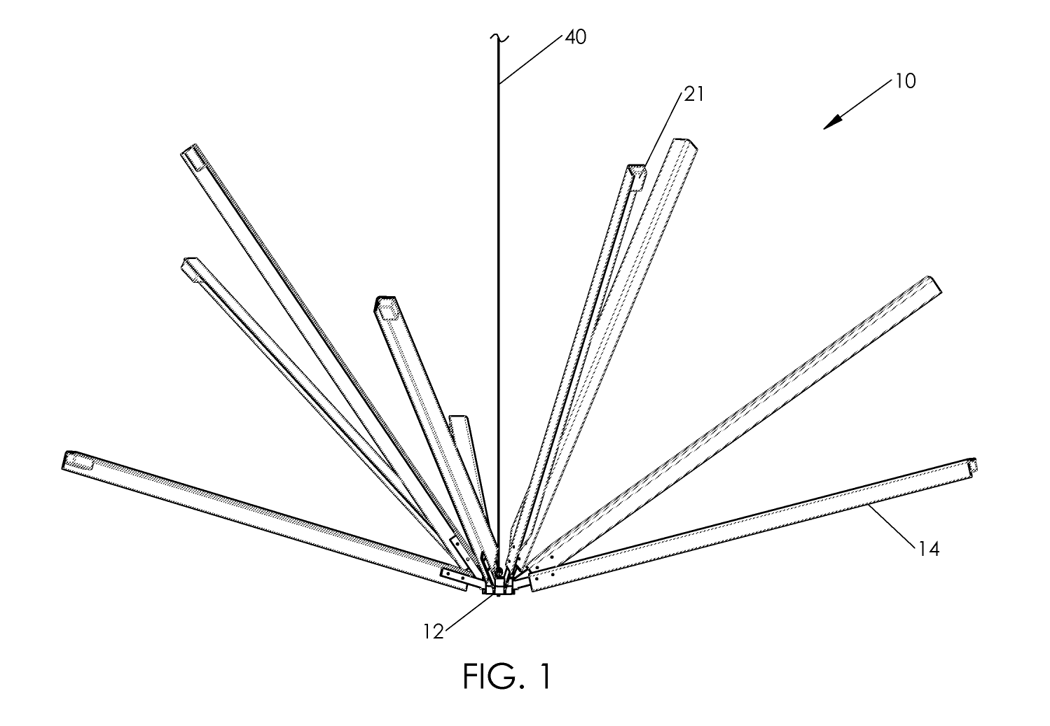

Referring now to FIG. 1, a side view of an apparatus for attracting fish is illustrated, in accordance with an embodiment of the invention. Fish attracting apparatus 10 is illustrated in an open or deployed configuration. Fish attracting apparatus 10, which is described in more detail below, comprises a plurality of limbs 14 affixed to a center hub 12. A float 21 is affixed to each limb to provide positive buoyancy to the limbs. In the illustrated embodiment, apparatus 10 comprises nine limbs, each one affixed at one of nine vertical channels. However, any desired number (even or odd) of limbs may be used, typically between four and twelve limbs. It is unlikely (although possible) that fewer than four limbs would be used, as so few limbs would provide limited functionality. It is also unlikely, (although possible) that greater than twelve limbs would be used, as the center hub would need to be so large that it would likely be unwieldy. The apparatus is suspended (such as from a boat on the surface of the water, or from the frozen surface of a lake) by way of line 40 affixed to center hub 12. As seen in FIG. 1, the limbs project from the hub at a plurality of different angles (although alternative embodiments of the invention (not illustrated) may comprise only limbs that all project from the hub as the same angle). Center hub 12 is illustrated as a circular structure (when viewed from the top or bottom), however any suitable shape may be used (e.g., square, octagon, triangle, etc.). Center hub 12 may be constructed of any suitable material that will tolerate extended submersion in water, such as any suitable plastic.

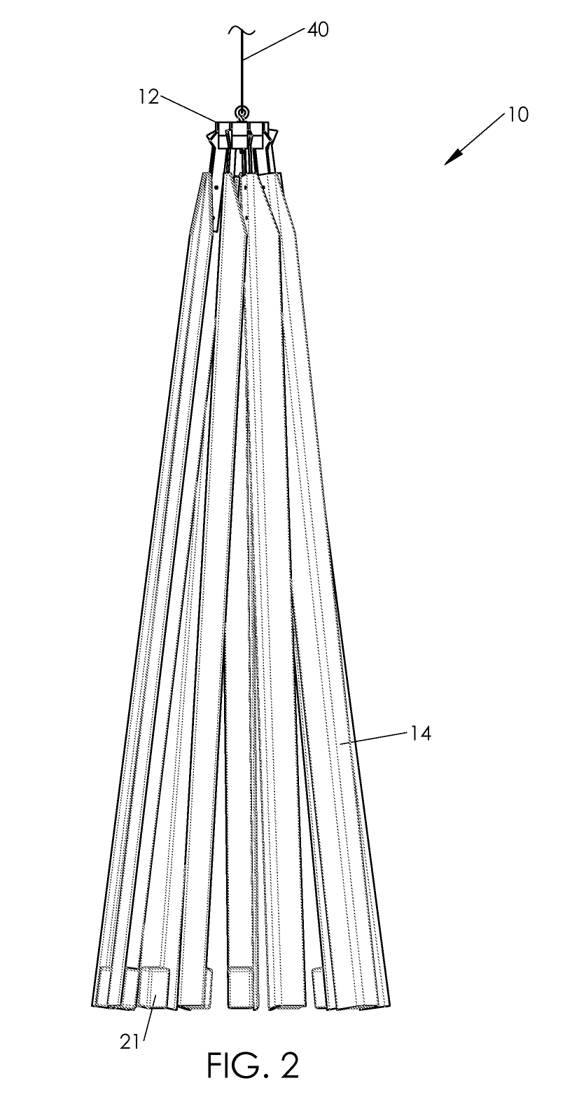

In FIG. 2, the apparatus 10 of FIG. 1 is illustrated in a closed/undeployed configuration. In embodiments of the invention, the limbs are hingedly affixed to the hub 12, such that the limbs 14 may be in one orientation (or set of orientations) when undeployed or in the process of being deployed (this may be termed a “closed” configuration), and another orientation (or set of orientations) when deployed (this may be termed an “open” configuration). As illustrated in FIG. 2, in the closed configuration all of the limbs may be aligned in the same general direction (hanging downward from the hub from the apparatus is upright). The compactness of the closed configurations enables easier transport of the apparatus. Advantageously, the compactness of the closed configurations also enables the apparatus to readily be inserted through a hole drilled through the frozen surface of a body of water for ice fishing. Such ice fishing holes are typically six to nine inches in diameter. In one embodiment of the invention, the diameter of the apparatus in a closed position is about ten to twelve inches at the bottom (due to the flaring outward discussed below). While this bottom measurement may be larger than a typical ice fishing hole, the bottom ends of the limbs may be pushed inward (due to the flexibility of the limbs) to temporarily reduce the measurement at the bottom to enable the apparatus to be inserted into a typical ice fishing hole. While the apparatus of embodiments of the invention may be particularly well suited to use in ice fishing, use of the apparatus of embodiments of the invention is not limited thereto. The apparatus of embodiments of the invention may be used in any suitable body of water, at any time of the year, for attracting fish or for any other suitable purpose(s).

When the apparatus 10 is submerged upright (or generally upright) in water, the distal end of each of the plurality of limbs floats upward such that each of the plurality of limbs pivots into a respective deployed position when the apparatus is submerged in water, resulting in the fully deployed arrangement illustrated in FIG. 1 (or similar).

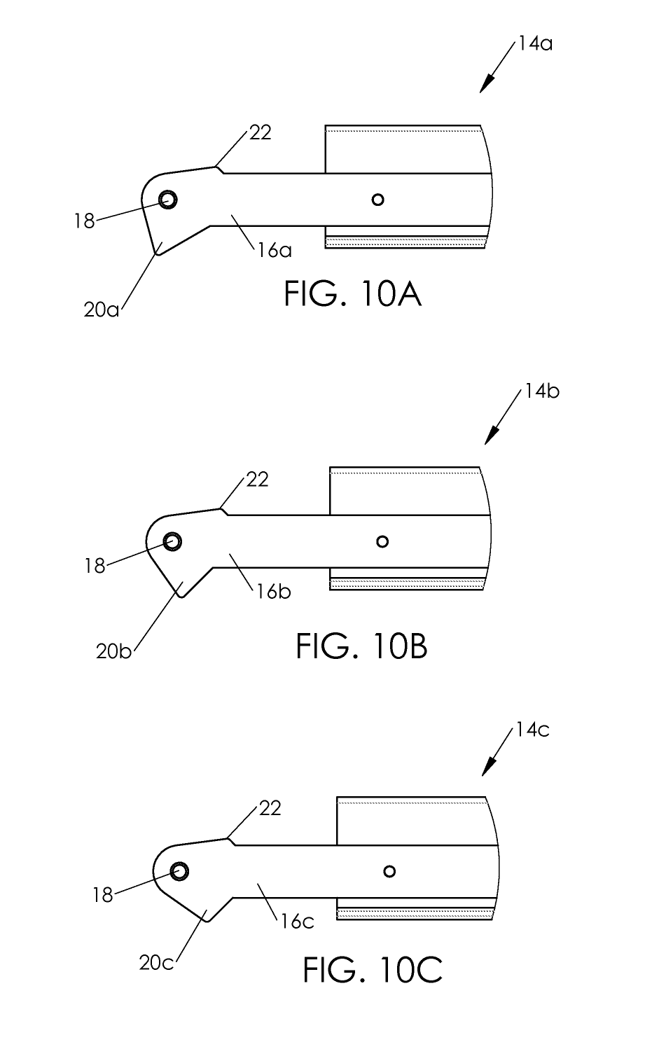

In FIG. 2, the apparatus 10 is illustrated with the limbs hanging down and angled slightly outward from the longitudinal axis of the center hub when in the undeployed position. This outward angling (or flaring) helps ensure that the limbs pivot outward and upward when the apparatus is submerged in water. Any suitable mechanism may be used to provide the outward angling of the limbs (such as projection 22 illustrated in FIGS. 10A-10C and described further below). Any suitable angle may be used, such as about three to about ten degrees, and preferably about five degrees. In alternative embodiments (not illustrated), the limbs may hang straight down from the center hub. However, in such an embodiment the limbs may not properly deploy when the apparatus is submerged in water.

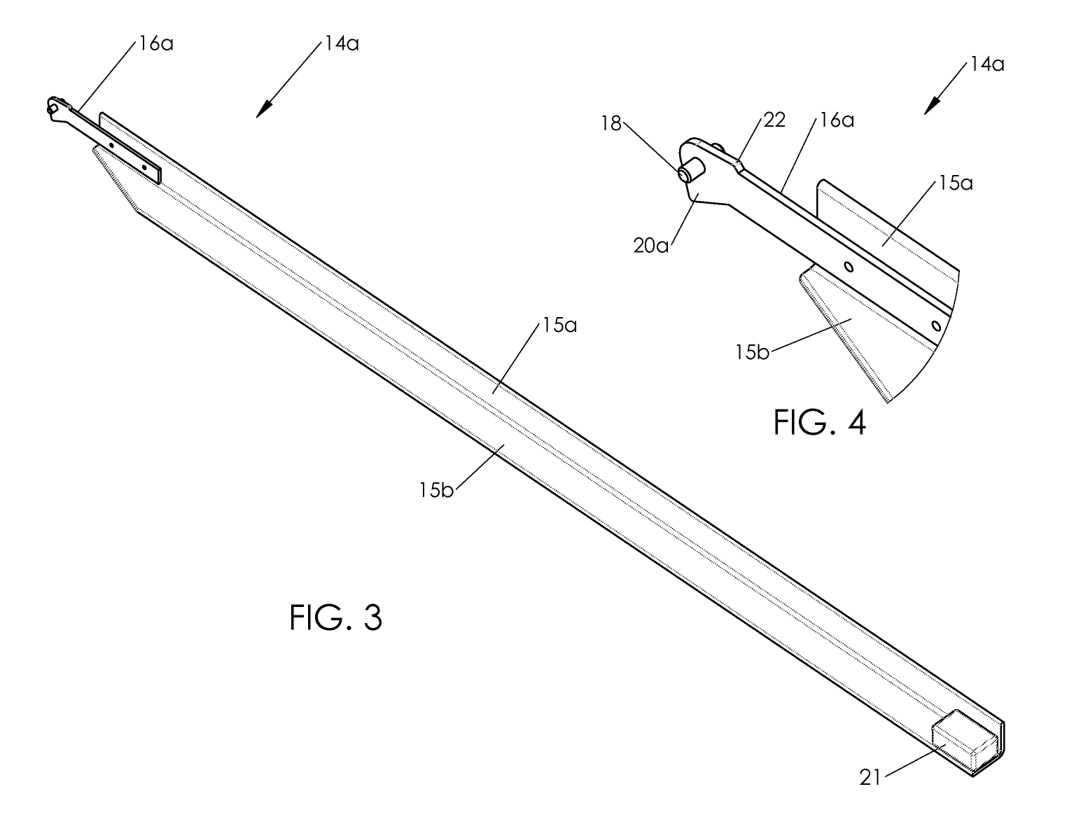

FIGS. 3 and 4 illustrate one of the plurality of limbs that may be affixed to hub 12. Each limb comprises an elongated structure constructed of any suitable material that will tolerate extended submersion in water, such as any suitable plastic. The material would preferably be natural looking. The material would typically be relatively dark in color (e.g., black, dark brown, dark green, dark grey, etc.). The color may be uniform or non-uniform (e.g., mottled). A single color or a mix of colors may be used. The material would typically have a roughly textured surface. In one embodiment of the invention, the limbs are about 48 inches in length. When fully deployed, the overall apparatus would then measure about 104 inches wide by about 40 inches tall.

As illustrated in FIG. 3, the limbs (limb 14a is illustrated in FIG. 3; limbs 14b, 14c have a similar structure and are discussed further below) may be generally “L” shaped. In such an “L” shaped configuration, each limb (such as illustrated limb 14a) comprises a radial wall 15a (so termed because this wall has an orientation that is radial to the longitudinal axis of the apparatus when the limbs are in the closed configuration) and a tangential wall 15b (so termed because this wall has an orientation that is tangential to the perimeter of the hub when the limbs are in the closed configuration). The walls may be planar, non-planar, or a combination of planar and non-planar. For example, the radial wall may be planar and the tangential wall may be non-planar, having a curve that matches the perimeter of the hub. The relative widths of the radial wall and the tangential wall may vary. Generally, the narrower the tangential wall is, the more limbs may be affixed to the hub. In one embodiment of the invention, the radial walls are about 1.75 inches wide and the tangential walls are about 1.75 inches wide. In an alternative embodiment, each limb may comprise only a radial wall (and no tangential wall) such that each limb is planar, thereby significantly increasing the number of limbs that may be affixed to the hub. Any other suitable shape may be used for the limbs, such as cylindrical or cuboid. As illustrated in FIGS. 1 and 2, the limbs may all have approximately the same length. Alternatively, multiple different length limbs may be used.

Each limb may comprise a float 21 (or multiple floats) affixed to the limb to provide positive buoyancy to the limbs to increase the tendency of the limbs to rise into the open configuration. The float may be any suitable positively buoyant material, such as closed cell polyethylene foam. The float may be affixed to the limb at any desirable location along the limb, but affixing the float at the distal end of the limb (as illustrated) may be desirable. The float may be affixed to the limb using any suitable means of affixation (not illustrated), such as a bolt and corresponding nut, rivets, or adhesive (such as double-sided tape). Alternatively, the limbs may be constructed of a positively buoyant material, in which case an additional float may not be necessary.

As illustrated in FIGS. 3 and 4, each limb (such as illustrated limb 14a) comprises a mechanism for hingedly or pivotably affixing the limb to hub 12, such as an attachment mechanism (such as illustrated attachment mechanism 16a) which is affixed to the proximal end of the limb (FIG. 4 provides a close up view of attachment mechanism 16a). Each attachment mechanism (such as illustrated attachment mechanism 16a) comprises a pivot finger 18 that extends perpendicularly from the attachment mechanism, as seen in FIG. 4. Each attachment mechanism is affixed to the corresponding limb using any suitable affixation mechanism, such as two or more rivets or two or more bolts and corresponding nuts. The affixation of the limbs to center hub 12 is described in detail below. The illustrated attachment mechanism 16a of limb 14 comprises projection 20a and projection 22, whose structure and function is discussed further below.

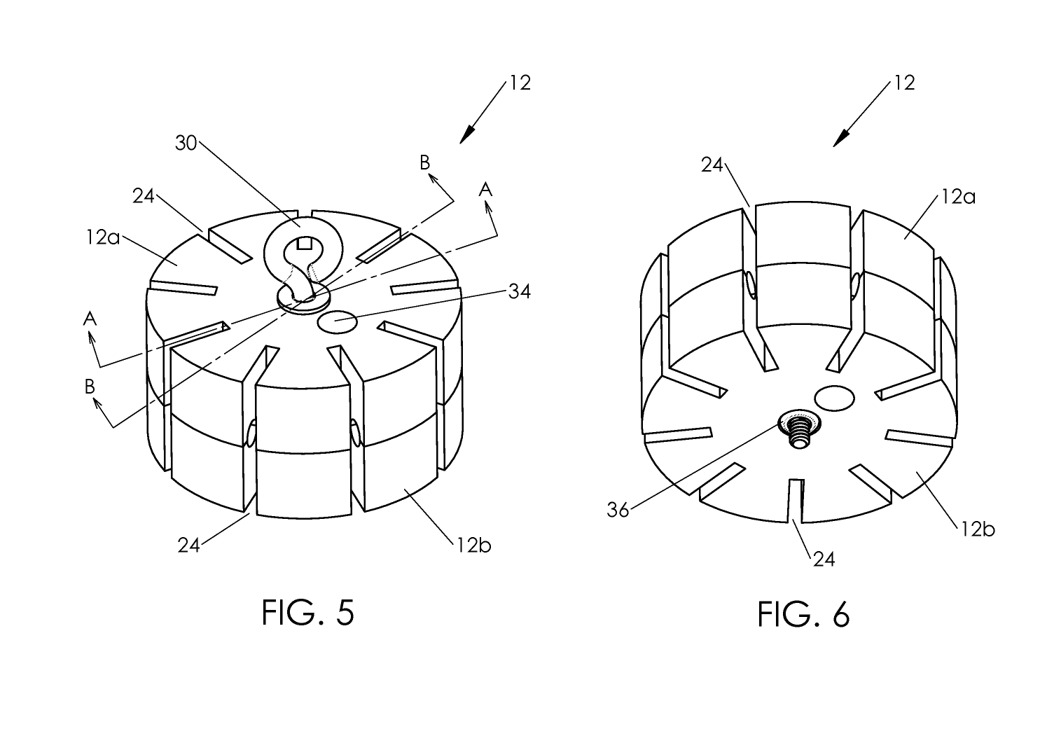

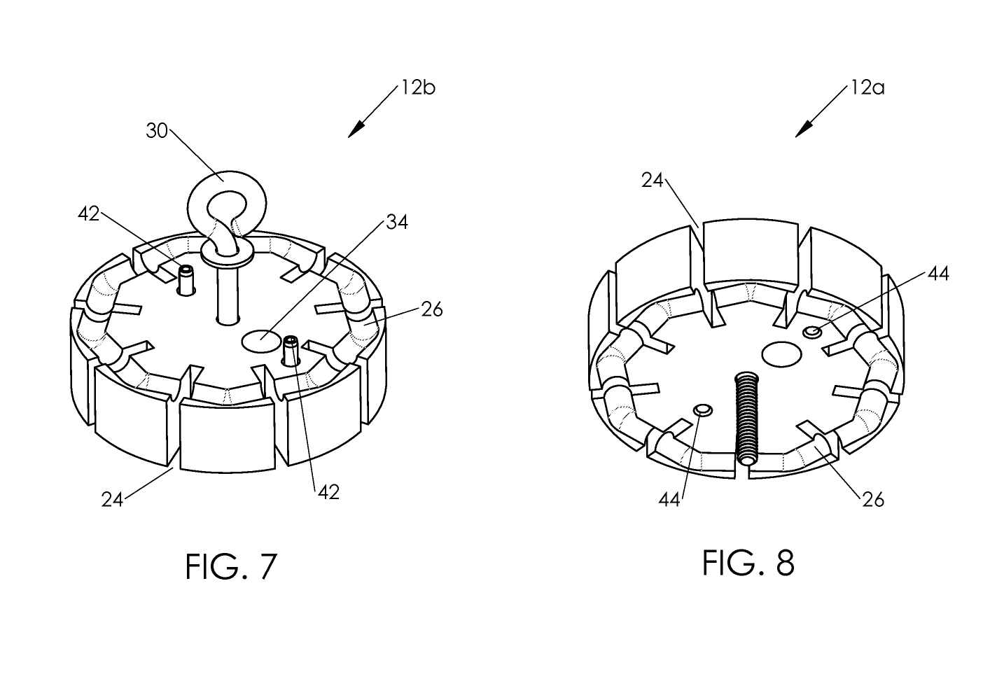

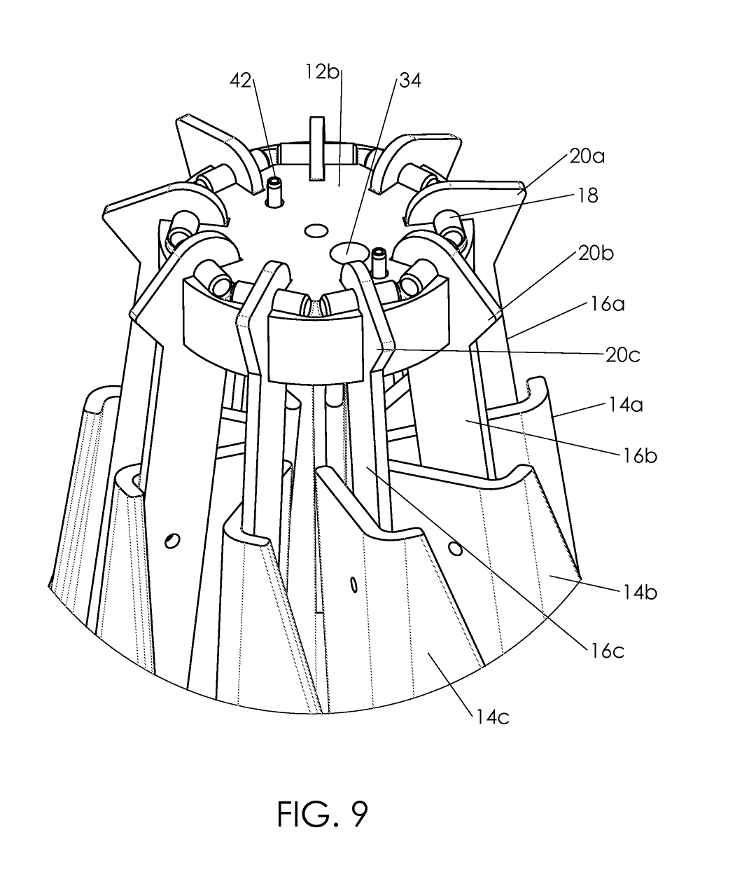

The structure of center hub 12 is further illustrated in FIGS. 5-9. FIGS. 5 and 6 are, respectively, top and bottom perspective views of center hub 12. FIG. 7 is a top perspective view of a bottom portion of center hub 12, with no limbs attached. FIG. 8 is a bottom perspective view of a top portion of center hub 12, with no limbs attached. FIG. 9 is a top perspective view of the bottom portion of center hub 12, with limbs attached. As seen in FIGS. 5-9, center hub 12 may be constructed as two mating pieces, a top portion 12a and a bottom portion 12b. However, it is not necessary that center hub 12 be constructed as two mating pieces. Center hub 12 may be constructed using more than two pieces, or may be constructed as a single piece. Center hub 12 may be constructed using any suitable manufacturing process, such as molding, casting, milling, etc. The top and bottom portions may be held together using any suitable affixation mechanism, such as center bolt 30 (which also forms the top line attachment mechanism) and nut 36 illustrated in FIGS. 5 and 6. One or more through-holes 34 may be defined within the top and bottom portions of the center hub. Such through-holes enable any air that is trapped under the center hub to escape when the apparatus is submerged. Such through-holes may also be configured to receive an elongated rod (not illustrated) that may be used to hold the apparatus is a generally upright position while the apparatus is being submerged to ensure that the apparatus maintains the correct orientation to facilitate the deployment of the limbs. After waiting a sufficient amount of time for the limbs to deploy (e.g., about 10-20 seconds), the elongated rod may be removed.

Apparatus 10 may comprise one or more line attachment mechanisms. FIG. 5 illustrates top line attachment mechanism 30. A bottom line attachment mechanism may be, for example, affixed to the bottom end of center bolt 30. The line attachment mechanisms may be, for example, eye bolts. Top line attachment mechanism 30 may be used, for example, to affix a line (such as line 40 in FIG. 1) that tethers apparatus 10 to the surface. Top line attachment mechanism 30 may also be used to suspend an object within the deployed limbs. For example, a cage containing bait fish (e.g., minnows) may be suspended on a line that is attached to top line attachment mechanism 30 such that the cage is within the deployed limbs. Such an arrangement is useful to attract other fish that feed on such bait fish. Additionally, an underwater light may be suspended within the deployed limbs.

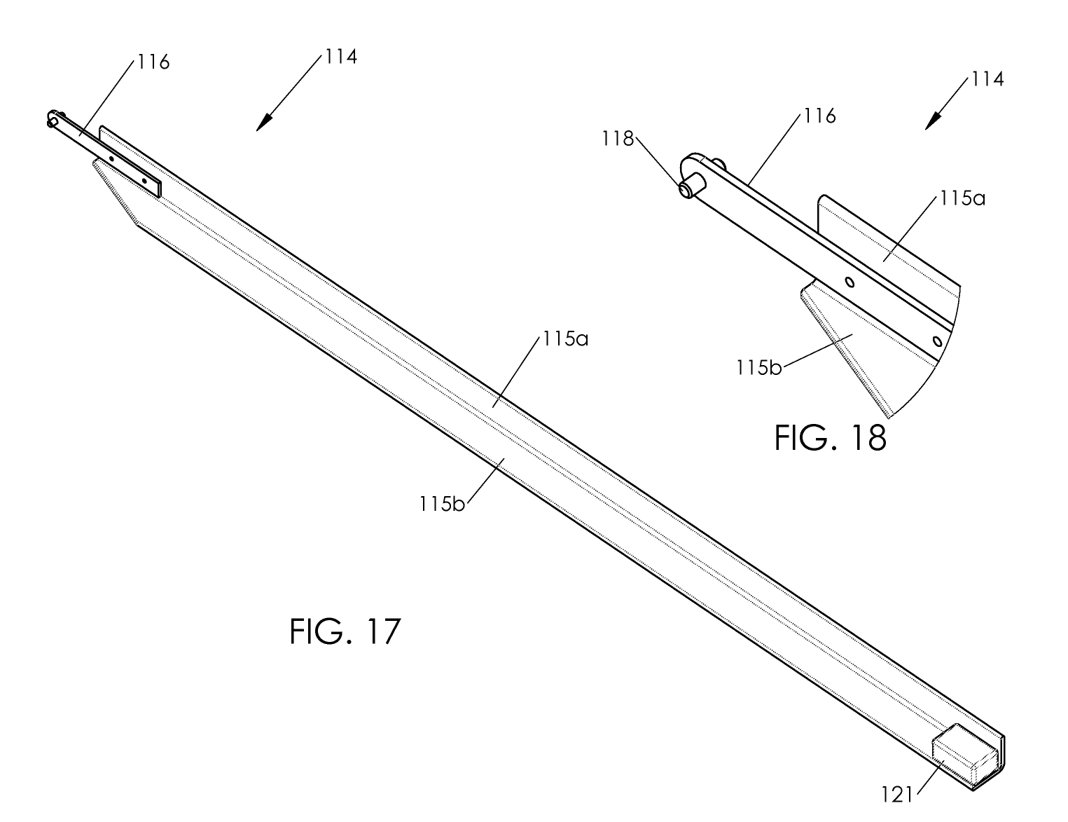

Apparatus 10 is typically positively buoyant overall, such that the apparatus will float when placed in a body of water. As such, added weight is typically attached to the apparatus to cause the apparatus to sink despite the positive buoyancy. A bottom line attachment mechanism may be used, for example, to attach such a weight to impart sufficient negative buoyancy to the apparatus if the apparatus is undesirably positively buoyant. As another example, a weight may be affixed to the bottom end of center bolt 30, such as by threading a generally cylindrical weight onto the threads of the bottom end of center bolt 30. As yet another example, a weight may be affixed to a wire or cable (such as a braided cable) that is in turn affixed to the bottom of center hub 12 (for example, to the bottom end of center bolt 30). Optionally, one or more relatively small individual weights 46 may be affixed to the bottom of center hub 12 (as illustrated in FIG. 16), such as via self-tapping screws. Similarly, one or more relatively small individual weights 48 may be affixed to the side of center hub 12, such as via self-tapping screws. Three bottom-mounted weights 46 and three side-mounted weights 48 are illustrated in FIG. 16 affixed to center hub 12.

Any suitable number and placement of weights may be added to the apparatus. Sufficient weight should be added to ensure sufficient negative buoyancy of the apparatus. Generally, the length/size/shape of the limbs and the materials the limbs are constructed of will control how much flotation (such as float 21) needs to be added to each limb to ensure the limbs deploy correctly. The total buoyancy of the apparatus (which is affected by the buoyancy of the limbs (including any added flotation) and the buoyancy of the center hub) dictates how much weight needs to be added to ensure sufficient negative buoyancy of the apparatus. In one embodiment of the invention in which four foot long limbs are used and sufficient flotation is added to each limb, it has been determined that about 1.7 ounces of weight is necessary to offset the buoyancy of each limb. Such needed weight can include the weight of the hub as well as any additional weights affixed to the apparatus. Such an embodiment may have nine limbs, in which case about 15.3 ounces of weight is needed in total. The added weights may be constructed of any suitable material, such as lead or steel.

In alternative embodiments of the invention, the apparatus may be negatively buoyant such that a weight need not be attached. How deep the apparatus will sink is controlled by a user based on what length of line 40 is let out. In use, the deployed depth of apparatus 10 should be far enough above the bottom surface of the body of water to enable all of the limbs to properly deploy.

Center hub 12 comprises a plurality of vertical channels 24. The number of channels corresponds to the number of limbs, such that one of each limb is affixed to center hub 12 at a separate one of the vertical channels 24. At least a portion of the attachment mechanism 16 of each of the plurality of limbs 14 moves up and down within its respective vertical channel 24 as the respective limb moves between its undeployed position and its deployed position. In the illustrated embodiment, each vertical channel 24 is partly defined by the top portion 12a and partly defined by the bottom portion 12b, such that each vertical channel 24 is fully defined when the top and bottom portions of center hub 12 are mated together. In one embodiment of the invention, the attachment mechanism 16 of each limb 14 fits relatively snugly (side-to-side) in its respective channels, thereby limiting the side-to-side movement of the limbs, particularly at the proximal ends (which in turn helps limit the side-to-side movement of the distal ends of the limbs, albeit to a lesser extent). Alternative embodiments of the invention may comprise a connection between the limbs and the hub in which a greater amount of side-to-side motion is possible, particularly at the distal ends. Up-and-down motion of the limbs between the closed position and the fully open position would typically be as unimpeded as possible in most or all embodiments of the invention.

As seen in FIGS. 7 and 8 (which illustrate, respectively, the top mating surface of the bottom portion 12b and the bottom mating surface of the top portion 12a), a plurality of horizontal cavities 26 are defined in center hub 12, each horizontal cavity 26 corresponding to and perpendicular to one of the vertical channels 24. In the illustrated embodiment, each horizontal cavity 26 is partly defined by the top portion 12a and partly defined by the bottom portion 12b, such that each horizontal cavity 26 is fully defined when the top and bottom portions of center hub 12 are mated together. The fully defined horizontal cavities 26 each have a generally cylindrical shape, although optional embodiments may have different shapes. Each horizontal cavity 26 receives a pivot finger 18 of the attachment mechanism 16 of a corresponding one of the limbs 14, as seen in FIG. 9. Each pivot finger 18 rotates within its respective horizontal cavity 26 as the respective limb 14 moves between its undeployed position and its deployed position. To assemble the apparatus 10, the attachment mechanism 16 of each limb 14 is inserted into its respective vertical channel 24 of the bottom portion 12b and the pivot finger 18 of each limb 14 is inserted into its respective horizontal channel 26 of the bottom portion 12b. Once all limbs 14 are thusly inserted, the top portion 12a is mated to the bottom portion 12b, taking care to align the vertical channel portions in the top portion 12a with the vertical channel portions in the bottom portion 12b. The top portion 12a and the bottom portion 12b may then be securely affixed together, such as with center bolt 30. This secure affixation of the top portion 12a and the bottom portion 12b of center hub 12 ensure retention of the limbs 14 to center hub 12, while still permitting the desired movement of the limbs. In one embodiment of the invention, one or more mating vertical cavities 44 (two are illustrated in FIGS. 7 and 8) are defined within the top portion 12a and the bottom portion 12b. An alignment pin 42 may be inserted into each vertical cavity 44 (as shown in FIG. 7) prior to mating the top portion 12a and the bottom portion 12b. As the top portion 12a and the bottom portion 12b are mated, each alignment pin 42 becomes fully enclosed within its respective vertical cavity 44, thereby ensuring that the top portion 12a and the bottom portion 12b cannot rotate independently of each other and ensuring that the top portion 12a and the bottom portion 12b maintain their proper alignment with respect to each other.

In one embodiment of the invention, illustrated in FIG. 9, each of the limbs 14 may be affixed to center hub 12 at a same level as each other of the plurality of limbs. In alternative embodiments of the invention, the limbs 14 may be affixed to center hub 12 at two or more different levels. In one embodiment of the invention, illustrated in FIG. 9, the limbs 14 are evenly spaced about a periphery of center hub 12. In alternative embodiments of the invention, the limbs 14 may be unevenly spaced.

In an alternative embodiment of the invention (not illustrated), a continuous ring is embedded within the hub such that each limb is affixed to the ring, although at different locations on the ring. In such an embodiment, a clip at the proximal end of each limb may be used to affix each limb to the ring. Many different alternative mechanisms may be used to hingedly or pivotably affix the limbs to the hub. For example, one alternative embodiment would use a similar clip attached to the limb, but rather than using a single continuous ring, the alternative embodiment would use a plurality of relatively short pins. Each pin would be embedded in the hub, with each separate pin passing through a different channel. Each of the short pins would be generally perpendicular to its corresponding channel. In another alternative embodiment, each clip attached to each limb may include a perpendicular pin that is press fit into a pin-receiving channel that is contiguous with and generally perpendicular to the vertical channel. In yet another alternative embodiment, each clip attached to each limb may include an enlarged ball portion that is press fit into a socket that is contiguous with each vertical channel.

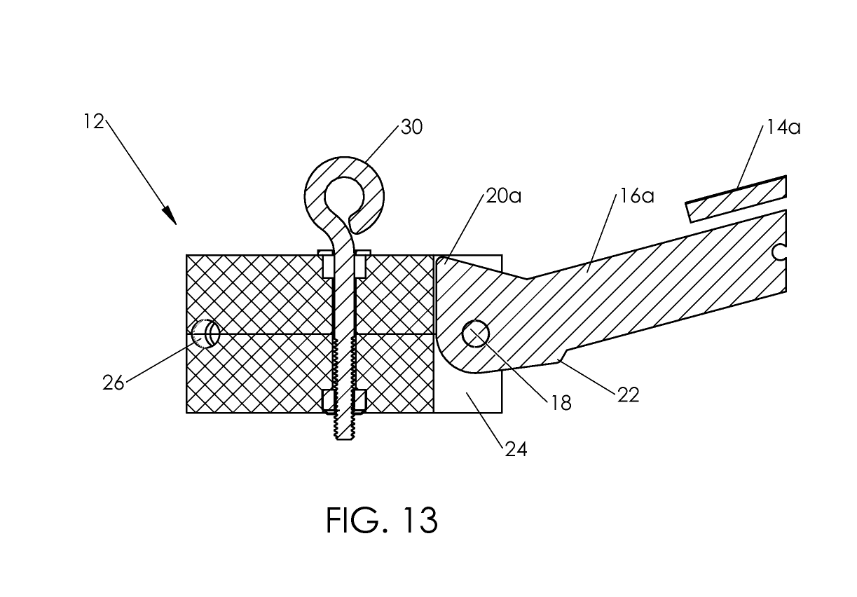

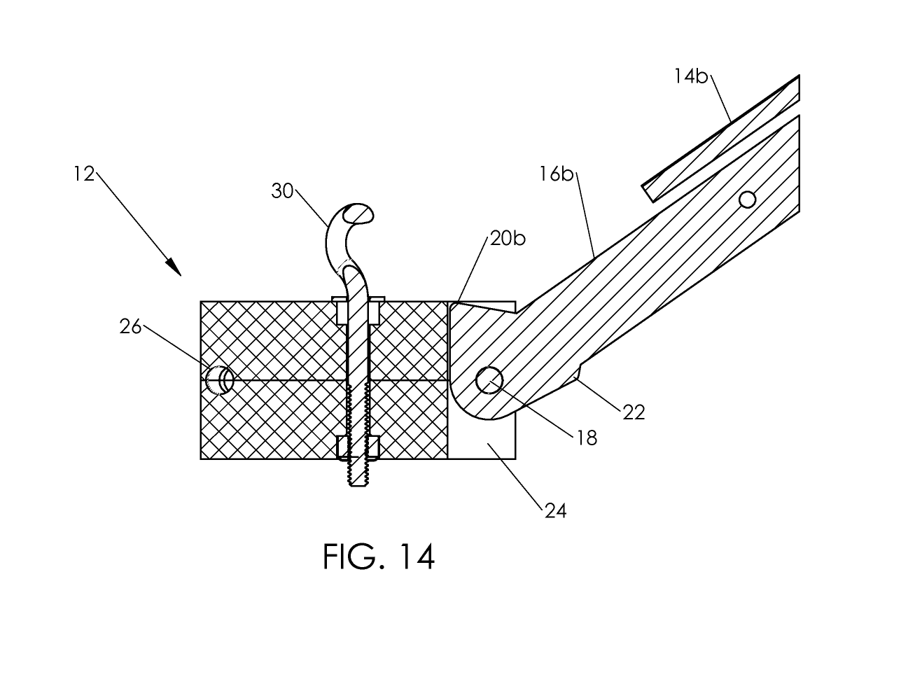

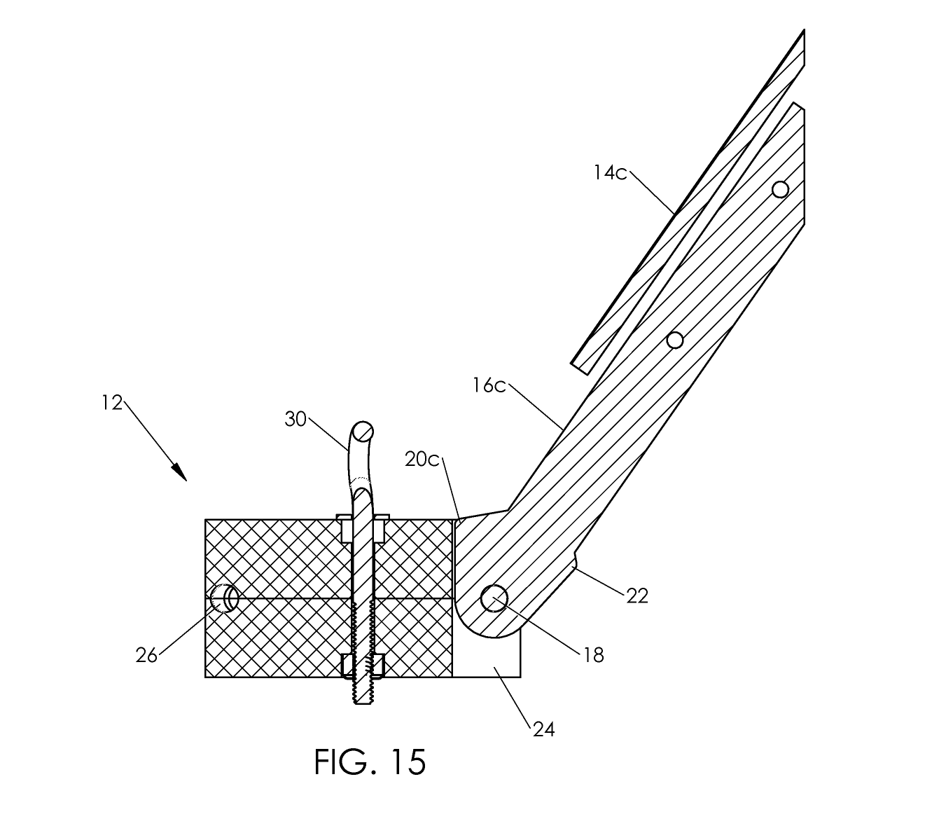

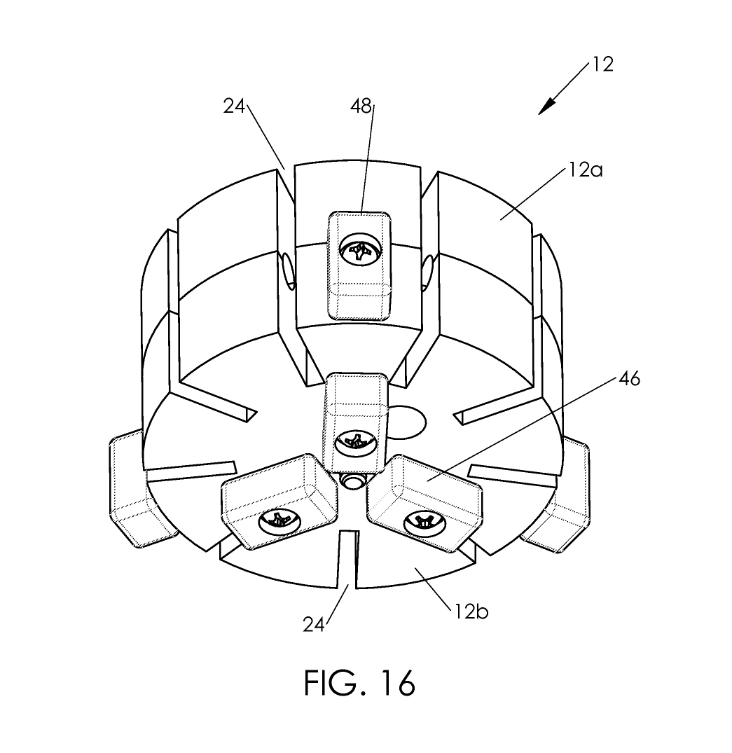

As discussed above, when deployed the limbs may, depending on the particular embodiment, project from the hub at a plurality of different angles. The use of different angles provides a structure that, when deployed, occupies a larger volume and provides a more realistic and effective structure for attracting fish than it otherwise would in the absence of such multiple different angles. The specific angles that are used may vary, the number of different angles may vary, and the number of each limb that project at a given angle may vary. Typically, at least two different angles are used. That is, at least two different ones of the limbs are at different angles relative to the longitudinal axis of the central hub when in their respective deployed positions. In the embodiment illustrated in FIG. 1, three different angles are used. Specifically, some limbs project at an angle that is angled upward toward the surface of the water at about 15 degrees (illustrated in FIG. 13), some limbs project at an angle that is angled upward toward the surface of the water at approximately 35 degrees (illustrated in FIG. 14), and some limbs project at an angle that is angled upward toward the surface of the water at approximately 55 degrees (illustrated in FIG. 15). The specific choices of 15, 35 and 55 degrees provide a reasonable dispersion of the limbs, but any desired angles may be used. In some alternative embodiments of the invention, some or all of the limbs may be angled downward away from the surface of the water when in a deployed position.

Each limb may be considered to belong to one of two or more groups of limbs, such that all limbs within a group are at the same angle relative to the longitudinal axis of the central hub when in their respective deployed positions, and such that all limbs within a group are at a different angle relative to the longitudinal axis of the central hub when in their respective deployed positions than all limbs in the other group or groups when in their respective deployed positions. The embodiment illustrated in FIG. 1 comprises three different groups of three limbs. Each of the three limbs in a particular group of limbs project at the same angle, which is different than the angles of the other two groups. In one alternative embodiment of the invention, each limb may project at a different angle from every other limb.

In the embodiment of FIG. 1, all of the limbs are either generally horizontal or project upward when in their respective deployed positions. As such, the embodiment of FIG. 1 is designed such that the apparatus may be deployed on or close to the bottom surface of the body of water when in use (although that is not necessary, and such an embodiment would work suspended above the bottom surface).

Many different mechanisms may be used in embodiments of the invention to control the angle of each limb relative to the longitudinal axis of the center hub when the respective limb is in its respective deployed position. Generally, the mating interface or structure between each of the plurality of limbs and the central hub controls the angle of each respective limb relative to the longitudinal axis of the central hub when the respective limb is in its respective deployed position.

In one embodiment of the invention, illustrated in FIGS. 1-16, each attachment mechanism comprises a projection that controls the angle of each respective limb relative to the longitudinal axis of the central hub when the respective limb is in its respective deployed position. The projection contacts a portion of the center hub when the respective limb is in its respective deployed position. Each projection controls the angle of its respective limb by preventing the respective limb from pivoting upward beyond its respective deployed position when the apparatus is submerged in water. A different projection is used for each different desired angle. In one embodiment of the invention, the projection contacts the innermost wall of its respective vertical channel (i.e., the narrow wall closest to the longitudinal axis of the center hub), above the level of the pivot finger 18, when the respective limb is in its respective deployed position. In such an embodiment, all of the vertical channels at which the limbs attach will have the same size and shape.

FIGS. 10A-10C illustrate the proximal ends of each of three different limbs, each limb having a different projection on its respective attachment mechanism such that each of the three different illustrated limbs will deploy at a different angle. Limb 14a comprises attachment mechanism 16a having projection 20a. The shape of projection 20a will cause limb 14a to deploy at angle that is angled upward toward the surface of the water at approximately 15 degrees. Limb 14b comprises attachment mechanism 16b having projection 20b. The shape of projection 20b will cause limb 14b to deploy at an angle that is angled upward to the surface of the water at approximately 35 degrees. Limb 14c comprises attachment mechanism 16c having projection 20c. The shape of projection 20c will cause limb 14c to deploy at an angle that is angled upward to the surface of the water at approximately 55 degrees. The attachment mechanism of each of limbs 14a, 14b and 14c also comprises projection 22, as discussed further below.

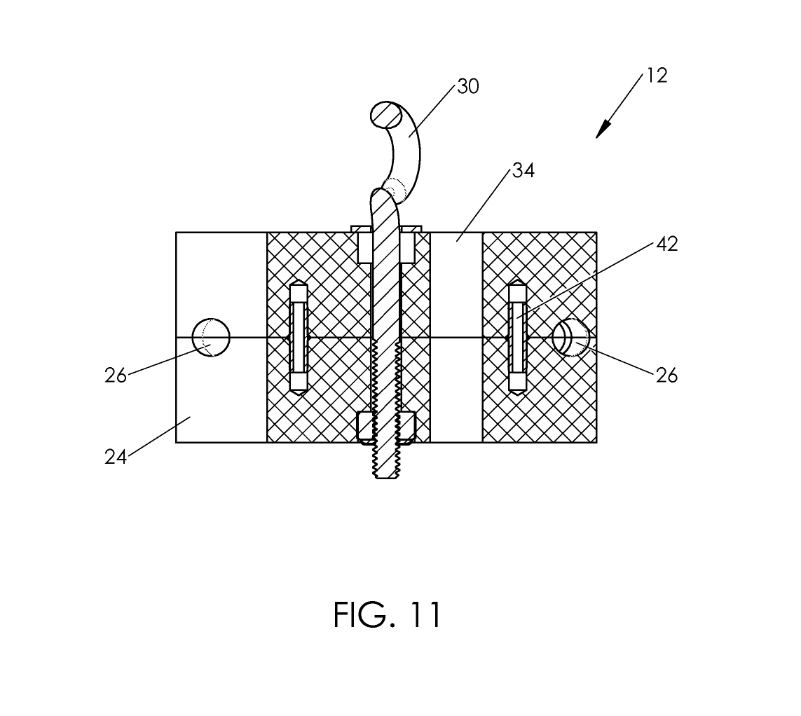

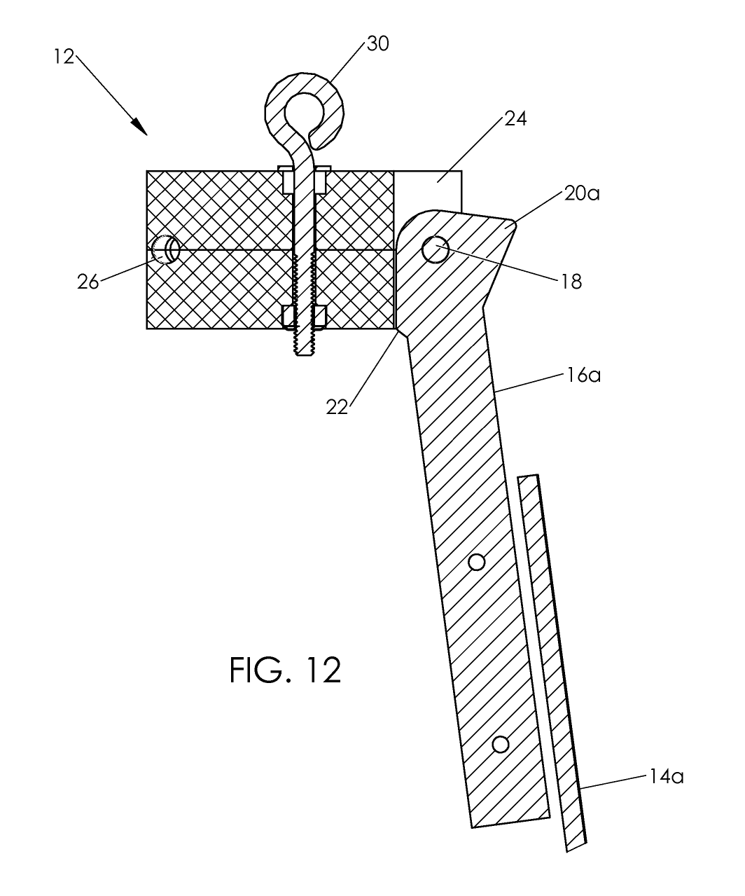

FIG. 11 is a cross-sectional view of center hub 12 along line A-A of FIG. 5, with no limbs attached. Visible in FIG. 11 is the interior profile of vertical channel 24. In the embodiment of the invention illustrated in FIGS. 1-16, the interior profiles of all of the vertical channels 24 are identical and the angle of each limb is controlled by the size and/or shape of the projection on its respective attachment mechanism. This is illustrated in detail in FIGS. 12-15.

FIG. 12 is a cross-sectional view of center hub 12 along line B-B of FIG. 5 with the attached limb (shown truncated) in an undeployed (downward) position (only one limb is illustrated for clarity). As illustrated in FIGS. 10A-10C, each attachment mechanism of each limb may comprise a projection 22 that controls the angle of each respective limb relative to the longitudinal axis of the central hub when the respective limb is in its respective undeployed position. When a limb is in its undeployed position, projection 22 contacts the innermost wall of its respective vertical channel (i.e., the narrow wall closest to the longitudinal axis of the center hub), below the level of the pivot finger 18. This is seen in FIG. 12. This causes the limbs to flare slightly outward from the longitudinal axis of the central hub at an angle of, for example, three to ten degrees when the apparatus is upright but not deployed in water. This flaring outward is seen in FIG. 2, although the amount of flaring in FIG. 2 is exaggerated for effect from a likely amount of flaring in a typical embodiment of the invention. Such outward flaring helps ensure that the limbs properly deploy by pivoting outward and upward, rather than possibly trying to pivot inward, when the apparatus is submerged in water. In alternative embodiments of the invention (not illustrated), the shape of the vertical channels or some other structural feature of the center hub (rather than a projection on the attachment mechanisms) may control the angle of each respective limb relative to the longitudinal axis of the central hub when the respective limb is in its respective undeployed position.

FIGS. 13-15 are cross-sectional views of center hub 12 along line B-B of FIG. 5, each showing the attached limb (shown truncated) deployed at a different angle (only one limb is illustrated in each figure for clarity). FIGS. 13-15 each show how the size and/or shape of each projection (20a, 20b, 20c) interfaces with the corresponding vertical channel 24 to control the deployment angle of the limb. Specifically, FIG. 13 illustrates how projection 20a of attachment mechanism 16a interfaces with vertical channel 24 to control the deployment angle of limb 14a such that limb 14a projects from center hub 12 at an angle that is angled upward toward the surface of the water at approximately 15 degrees. Similarly, FIG. 14 illustrates how projection 20b of attachment mechanism 16b interfaces with vertical channel 24 to control the deployment angle of limb 14b such that limb 14b projects from center hub 12 at an angle that is angled upward to the surface of the water at approximately 35 degrees. FIG. 14 illustrates how projection 20c of attachment mechanism 16c interfaces with vertical channel 24 to control the deployment angle of limb 14c such that limb 14c projects from center hub 12 at an angle that is angled upward to the surface of the water at approximately 55 degrees. The specific angles illustrated in FIGS. 13-15 are for illustration purposes. As discussed above, the specific angles that are used may vary, the number of different angles may vary, and the number of each limb that project at a given angle may vary.

In alternative embodiments of the invention, the angle of each limb is controlled by a physical structure of the channels, such as the height and shape of the internal cavities, the angle of a top internal surface of each channel, and/or the height, shape and/or angle of the opening of each channel. In such embodiments, the attachment mechanisms of the limbs would not include projections (such as projections 20a, 20b, or 20c) (although the attachment mechanisms of the limbs may still include projections to cause an outward flare of the limbs when in the undeployed position (such as projection 22). As in the embodiments described above, any suitable angles may be used, and any desired number of different angles may be used.

Referring now to FIGS. 17 and 18, limb 114 of such an alternative embodiment of the invention is illustrated. As with the limb illustrated in FIGS. 3 and 4, limb 114 may be generally “L” shaped. In such an “L” shaped configuration, limb 114 comprises a radial wall 115a (so termed because this wall has an orientation that is radial to the longitudinal axis of the apparatus when the limbs are in the closed configuration) and a tangential wall 115b (so termed because this wall has an orientation that is tangential to the perimeter of the hub when the limbs are in the closed configuration). As with the limb illustrated in FIGS. 3 and 4, the walls of limb 114 may be planar, non-planar, or a combination of planar and non-planar. The relative widths of the radial wall and the tangential wall may vary. Any other suitable shape may be used for the limbs, such as cylindrical or cuboid. Each of limb 114 may comprise a float 121 (or multiple floats) affixed to the limb to provide positive buoyancy to the limbs to increase the tendency of the limbs to rise into the open configuration.

As with the limb illustrated in FIGS. 3 and 4, each of limb 114 comprises a mechanism for hingedly or pivotably affixing the limb to a center hub, such as attachment mechanism 116 which is affixed to the proximal end of limb 114 (FIG. 18 provides a close up view of attachment mechanism 116). Because the angle of each limb is controlled by a physical structure of the channels in this alternative embodiment, attachment mechanism 116 will be identical for each of limb 114 affixed to the same center hub. Each of attachment mechanism 116 comprises a pivot finger 118 that extends perpendicularly from the attachment mechanism, as seen in FIG. 18. Each attachment mechanism is affixed to the corresponding limb using any suitable affixation mechanism, such as two or more rivets or two or more bolts and corresponding nuts. The affixation of limb 114 to a center hub would be the same as is described above in relation to limbs 14a, 14b, and 14c, although alternative attachment structures may be used. Although not illustrated, the attachment mechanism 116 of limb 114 may comprise a projection to provide the outward angling of the limbs when the limbs are undeployed positions (similar to projection 22 of the limb illustrated in FIGS. 3 and 4).

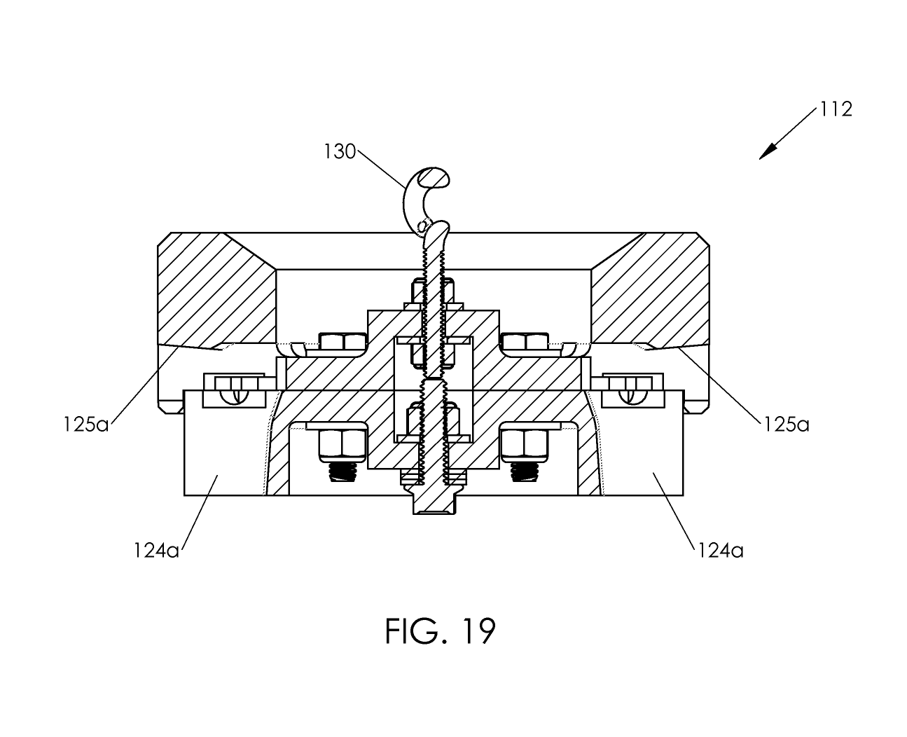

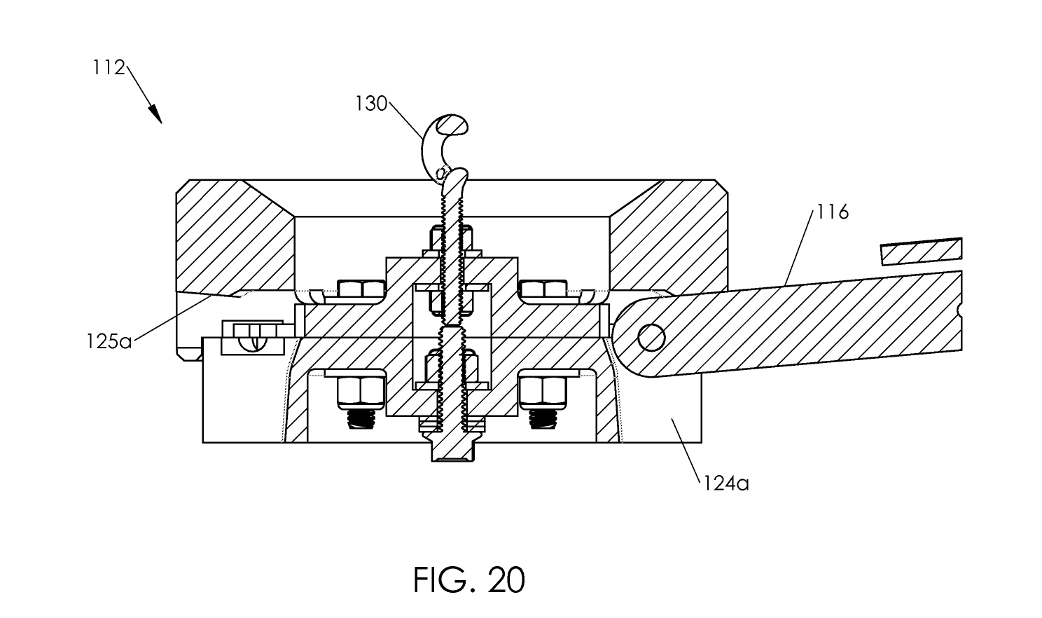

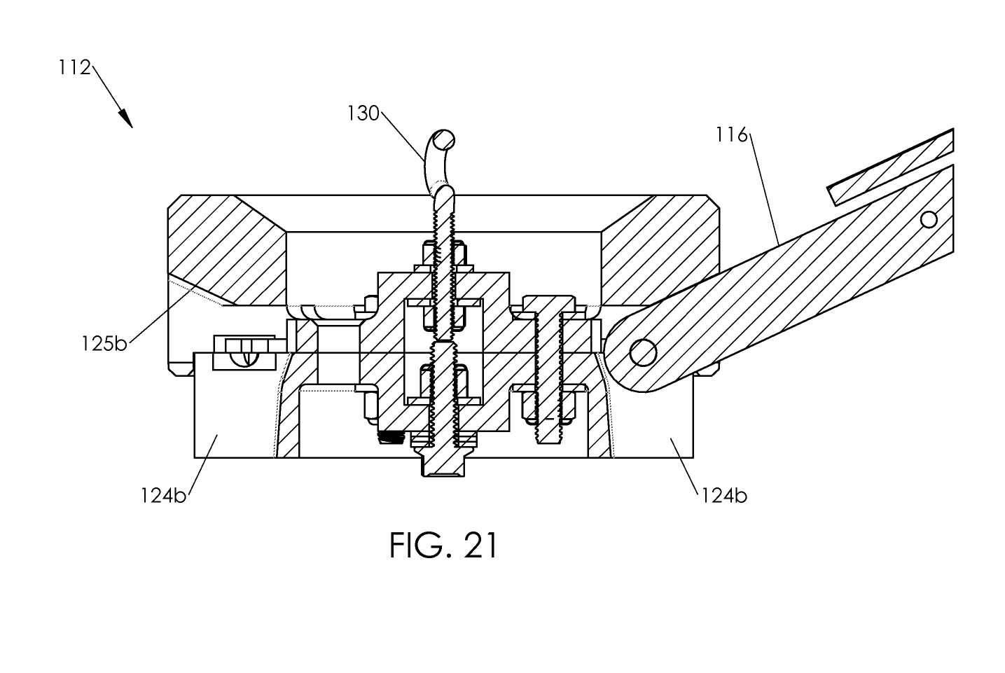

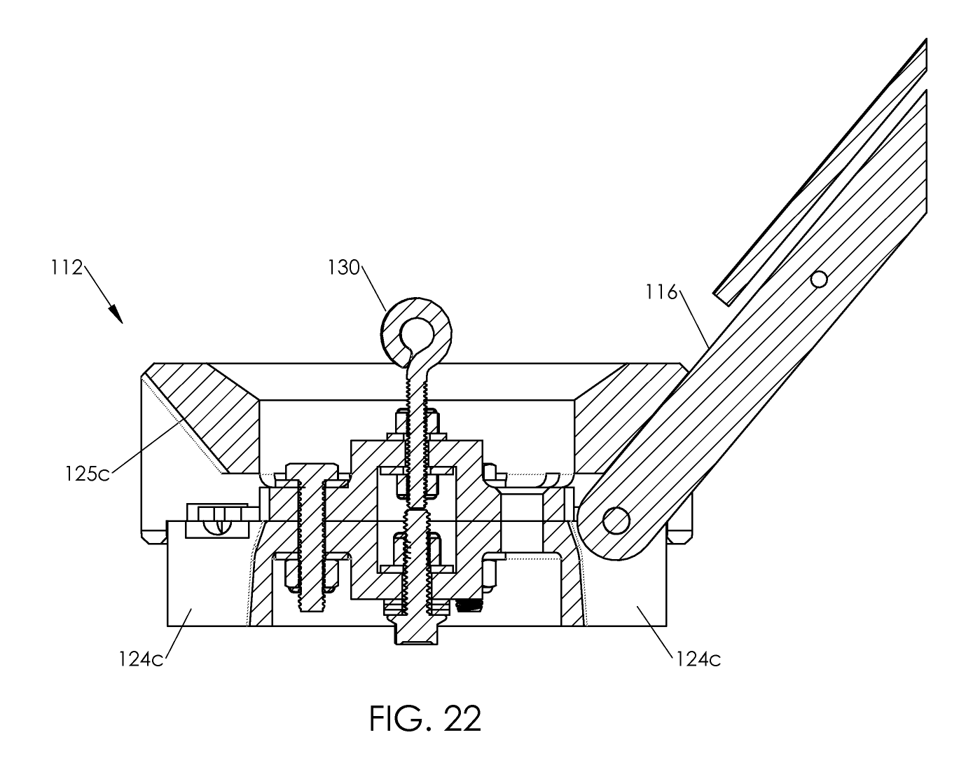

One possible structure of the channels used to control the angle of the limbs in alternative embodiments of the invention is illustrated in FIGS. 19-22. FIG. 19 is a cross-sectional view of an alternative center hub, with no limbs attached. FIG. 20 is the same cross-sectional view as FIG. 19, but with one limb attached. FIGS. 21 and 22 show different cross-sectional views of the center hub of FIG. 19, each showing one attached limb deployed at a different angle. Center hub 112 is very similar to center hub 12 described above. Center hub 112 comprises top and bottom portions (not labeled) affixed together by bolts (not labeled) and having a top line attachment mechanism 130. Vertical channels are defined in center hub 112. The structure of each vertical channel controls the angle of deployment of the corresponding limb.

In the embodiment illustrated in FIGS. 19-22, three different channel structures are illustrated. FIGS. 19 and 20 illustrate vertical channels 124a that have a top wall 125a that is angled upward (i.e., toward the surface of the water when the apparatus is deployed upright in water) at approximately 15 degrees. When deployed, the attachment mechanism 116 of the limbs affixed at vertical channels 124a contacts the top wall 125a such that the limbs affixed at vertical channels 124a project at an angle that is slightly angled upward toward the surface of the water at approximately 15 degrees (illustrated in FIG. 20). FIG. 21 illustrates vertical channels 124b that have a top wall 125b that is angled upward (i.e., toward the surface of the water when the apparatus is deployed upright in water) at approximately 35 degrees. When deployed, the attachment mechanism 116 of the limbs affixed at vertical channels 124b contacts the top wall 125b such that the limbs affixed at vertical channels 124b project at an angle that is angled upward to the surface of the water at approximately 35 degrees (illustrated in FIG. 21). FIG. 22 illustrates vertical channels 124c that have a top wall 125c that is angled upward (i.e., more acutely toward the surface of the water when the apparatus is deployed upright in water) at approximately 55 degrees. When deployed, the attachment mechanism 116 of the limbs affixed at vertical channels 124c contacts the top wall 125c such that the limbs affixed at vertical channels 124c project at an angle that is angled upward to the surface of the water at approximately 55 (illustrated in FIG. 22). These specific choices need not be used, but rather any desired angles may be used.

In other alternative embodiments, the channels may all have the same internal shape and different “stops” may be positioned at the openings of the channels to control the angles of the deployed limbs. In yet other alternative embodiments, the channels may all have the same internal shape and different “stops” may be positioned within each channel to control the angles of the deployed limbs.

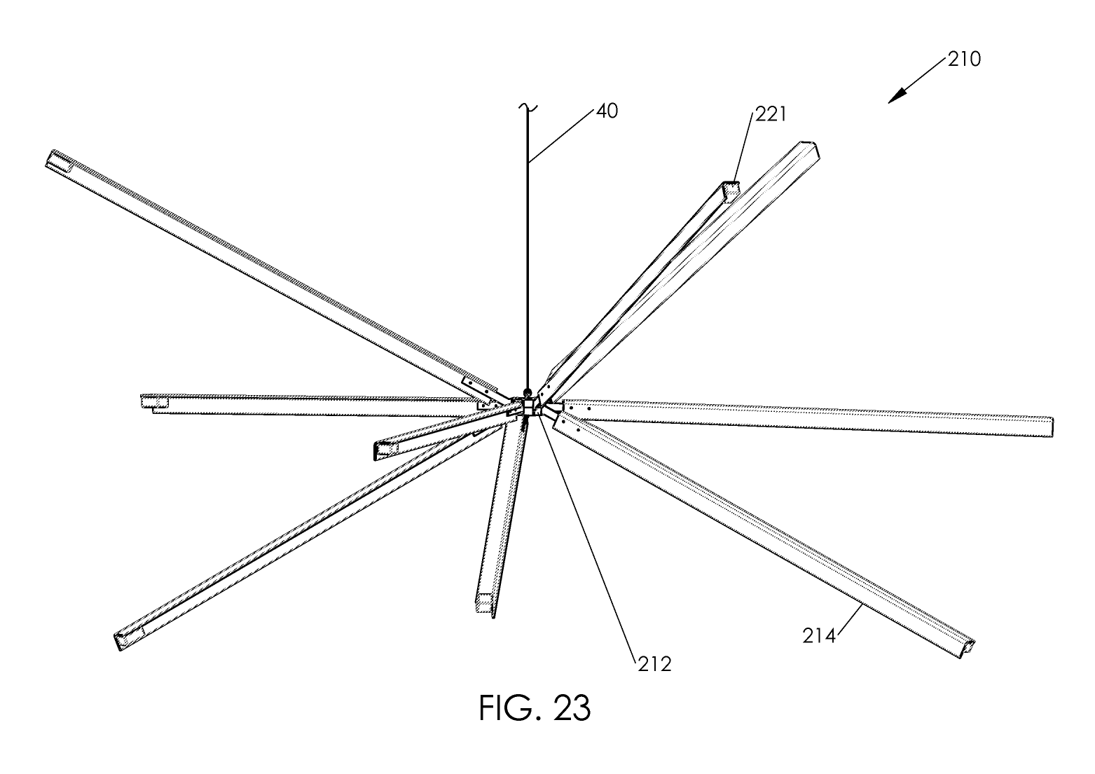

FIG. 23 illustrates an alternative embodiment of the invention. Like the embodiment of FIGS. 1-16, fish attracting apparatus 210 of FIG. 23 comprises a plurality of limbs 214 affixed to a center hub 212, and the limbs project from the hub at a plurality of different angles. Each limb 214 may comprise a float 221. The center hub 212 may be affixed to a line 40. However, the embodiment of FIG. 23 is designed such that the apparatus is intended to be positioned sufficiently above the bottom surface of the body of water when in use because some of the limbs project downward when in their deployed positions. In the illustrated embodiment, three different angles are used and every third limb projects at the same angle. Specifically, some limbs project at an angle that is substantially parallel to the surface of the water, some limbs project at an angle that is angled upward to the surface of the water at approximately 40-50 degrees (and preferably about 45 degrees), and some limbs project at an angle that is angled downward away from the surface of the water at approximately 40-50 degrees (and preferably about 45 degrees).

In alternative embodiments of the invention, one or more limbs may be substantially rigidly affixed to the center hub, such that the one or more limbs maintain a substantially vertical orientation pointing downward toward the bottom surface of the body of water. In other alternative embodiments of the invention, one or more limbs may be hingedly or pivotably affixed to center hub in such a way that the one or more limbs pivot to a substantially vertical orientation pointing upward toward the surface of the body of water.

A float (not illustrated) may be affixed to an apparatus of embodiments of the invention. Such a float is sized and shaped to float in the ice fishing hole when the apparatus is deployed, thereby both supporting the fish attracting apparatus at the desired depth and helping to keep the ice fishing hole from refreezing.

The angles and orientations described herein are based on an assumption that the top surface of the hub will be substantially parallel to the surface of the water during use. This is for descriptive purposes only. There is no requirement that an apparatus of embodiments of the invention must maintain such an orientation during use. In fact, it is expected that the orientation of an apparatus of embodiments of the invention will change (at least somewhat) frequently (if not continuously) during use. It is also expected that the angle of some or all of the limbs will change (at least somewhat) as the apparatus moves in the water. The buoyancy of the limbs will tend to bias the limbs upward into their respective angles, but movement of the water and/or of the apparatus will sometimes cause some or all of the limbs to pivot downward temporarily.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. An apparatus for attracting fish comprising:
a central hub; and
a plurality of arms each having a proximal end comprising an attachment mechanism and a distal end, and each being pivotably affixed to the central hub at its proximal end via the attachment mechanism;
wherein each of the plurality of arms depend downward from the central hub in a respective undeployed position when the apparatus is upright but not deployed in water;
wherein the distal end of each of the plurality of arms is configured to float upward such that each of the plurality of arms pivots into a respective deployed position when the apparatus is submerged in water; and
wherein at least a portion of the attachment mechanism of each of the plurality of arms moves up and down within a respective vertical channel defined in the central hub as the respective arm moves between its undeployed position and its deployed position.

2. The apparatus of claim 1, wherein each of the plurality of arms is affixed to the central hub at a same level as each other of the plurality of arms.

3. The apparatus of claim 1, wherein the plurality of arms are evenly spaced about a periphery of the central hub.

4. The apparatus of claim 1, wherein each of the plurality of arms is either constructed of a buoyant material or has buoyant material attached thereto or both.

5. The apparatus of claim 1, wherein at least two different ones of the plurality of arms are at different angles relative to a longitudinal axis of the central hub when in their respective deployed positions.

6. The apparatus of claim 1, wherein each of the plurality of arms belongs to one of two or more groups of arms; wherein all arms within a same group are at a same angle relative to a longitudinal axis of the central hub when in their respective deployed positions; and wherein all arms within a same group are at a different angle relative to the longitudinal axis of the central hub when in their respective deployed positions than all arms in the other group or groups when in their respective deployed positions.

7. The apparatus of claim 1, wherein a pivot finger extends perpendicularly from the attachment mechanism of each of the plurality of arms; and wherein the pivot finger of each of the plurality of arms rotates within a respective horizontal cavity defined in the central hub as the respective arm moves between its undeployed position and its deployed position.

8. The apparatus of claim 1, wherein each attachment mechanism comprises a projection that contacts a portion of the central hub when the respective arm is in its respective deployed position to thereby prevent the respective arm from pivoting upward beyond its respective deployed position.

9. The apparatus of claim 1, wherein each attachment mechanism comprises a projection that controls an angle of each respective arm relative to a longitudinal axis of the central hub when the respective arm is in its respective deployed position.

10. The apparatus of claim 1, wherein a mating interface between each of the plurality of arms and the central hub controls an angle of each respective arm relative to a longitudinal axis of the central hub when the respective arm is in its respective deployed position.

11. The apparatus of claim 1, wherein each of the plurality of arms depend downward and outward from the central hub in its respective undeployed position such that all of the arms flare outward from a longitudinal axis of the central hub when the apparatus is upright but not deployed in water.

12. The apparatus of claim 11, wherein each attachment mechanism comprises a projection that controls an angle of each respective arm relative to the longitudinal axis of the central hub when the respective arm is in its respective undeployed position.

13. The apparatus of claim 11, wherein each of the plurality of arms flare outward from the longitudinal axis of the central hub at an angle of three to ten degrees when the apparatus is upright but not deployed in water.

14. The apparatus of claim 1, wherein either the apparatus comprises a weight affixed to the central hub or the central hub is negatively buoyant such that the entire apparatus is either neutrally buoyant or negatively buoyant.

15. A method of attracting fish comprising:
submerging a fish attracting apparatus in a body of water, the fish attracting apparatus comprising:
a central hub; and
a plurality of arms each having a proximal end comprising an attachment mechanism and a distal end and each being pivotably affixed to the central hub at its proximal end via the attachment mechanism;
wherein each of the plurality of arms depend downward from the central hub in a respective undeployed position when the apparatus is upright but not deployed in water;
wherein the distal end of each of the plurality of arms is configured to float upward such that each of the plurality of arms pivots into a respective deployed position when the apparatus is submerged in water; and
wherein at least a portion of the attachment mechanism of each of the plurality of arms moves up and down within a respective vertical channel defined in the central hub as the respective arm moves between its undeployed position and its deployed position.

16. The method of claim 15, wherein each of the plurality of arms is affixed to the central hub at a same level as each other of the plurality of arms.

17. The method of claim 15, wherein the plurality of arms are evenly spaced about a periphery of the central hub.

18. The method of claim 15, wherein each of the plurality of arms is either constructed of a buoyant material or has buoyant material attached thereto or both.

19. The method of claim 15, wherein at least two different ones of the plurality of arms are at different angles relative to a longitudinal axis of the central hub when in their respective deployed positions.

20. The method of claim 15, wherein each of the plurality of arms belongs to one of two or more groups of arms; wherein all arms within a same group are at a same angle relative to a longitudinal axis of the central hub when in their respective deployed positions; and wherein all arms within a same group are at a different angle relative to the longitudinal axis of the central hub when in their respective deployed positions than all arms in the other group or groups when in their respective deployed positions.

21. The method of claim 15, wherein a pivot finger extends perpendicularly from the attachment mechanism of each of the plurality of arms; and wherein the pivot finger of each of the plurality of arms rotates within a respective horizontal cavity defined in the central hub as the respective arm moves between its undeployed position and its deployed position.

22. The method of claim 15, wherein each attachment mechanism comprises a projection that contacts a portion of the central hub when the respective arm is in its respective deployed position to thereby prevent the respective arm from pivoting upward beyond its respective deployed position.

23. The method of claim 15, wherein each attachment mechanism comprises a projection that controls an angle of each respective arm relative to a longitudinal axis of the central hub when the respective arm is in its respective deployed position.

24. The method of claim 15, wherein a mating interface between each of the plurality of arms and the central hub controls an angle of each respective arm relative to a longitudinal axis of the central hub when the respective arm is in its respective deployed position.

25. The method of claim 15, wherein each of the plurality of arms depend downward and outward from the central hub in its respective undeployed position such that all of the arms flare outward from a longitudinal axis of the central hub when the apparatus is upright but not deployed in water.

26. The method of claim 25, wherein each attachment mechanism comprises a projection that controls an angle of each respective arm relative to the longitudinal axis of the central hub when the respective arm is in its respective undeployed position.

27. The method of claim 25, wherein each of the plurality of arms flare outward from the longitudinal axis of the central hub at an angle of three to ten degrees when the apparatus is upright but not deployed in water.

28. The method of claim 15, wherein either the apparatus comprises a weight affixed to the central hub or the central hub is negatively buoyant such that the entire apparatus is either neutrally buoyant or negatively buoyant.

29. The method of claim 15, further comprising:
creating a hole in ice covering at least a portion of the body of water; and
inserting the fish attracting apparatus through the created hole and into the body of water.

30. An apparatus for attracting fish comprising:
a central hub; and
a plurality of arms each having a proximal end and a distal end and each being pivotably affixed to the central hub at its proximal end;
wherein each of the plurality of arms depend downward and outward from the central hub in a respective undeployed position when the apparatus is upright but not deployed in water such that all of the arms flare outward from a longitudinal axis of the central hub when the apparatus is upright but not deployed in water; and
wherein the distal end of each of the plurality of arms is configured to float upward such that each of the plurality of arms pivots into a respective deployed position when the apparatus is submerged in water.

31. The apparatus of claim 30, wherein each of the plurality of arms is affixed to the central hub at a same level as each other of the plurality of arms.

32. The apparatus of claim 30, wherein the plurality of arms are evenly spaced about a periphery of the central hub.

33. The apparatus of claim 30, wherein each of the plurality of arms is either constructed of a buoyant material or has buoyant material attached thereto or both.

34. The apparatus of claim 30, wherein at least two different ones of the plurality of arms are at different angles relative to a longitudinal axis of the central hub when in their respective deployed positions.

35. The apparatus of claim 30, wherein each of the plurality of arms belongs to one of two or more groups of arms; wherein all arms within a same group are at a same angle relative to a longitudinal axis of the central hub when in their respective deployed positions; and wherein all arms within a same group are at a different angle relative to the longitudinal axis of the central hub when in their respective deployed positions than all arms in the other group or groups when in their respective deployed positions.

36. The apparatus of claim 30, wherein the proximal end of each of the plurality of arms comprises an attachment mechanism; and wherein at least a portion of the attachment mechanism of each of the plurality of arms moves up and down within a respective vertical channel defined in the central hub as the respective arm moves between its undeployed position and its deployed position.

37. The apparatus of claim 36, wherein a pivot finger extends perpendicularly from the attachment mechanism of each of the plurality of arms; and wherein the pivot finger of each of the plurality of arms rotates within a respective horizontal cavity defined in the central hub as the respective arm moves between its undeployed position and its deployed position.

38. The apparatus of claim 36, wherein each attachment mechanism comprises a projection that contacts a portion of the central hub when the respective arm is in its respective deployed position to thereby prevent the respective arm from pivoting upward beyond its respective deployed position.

39. The apparatus of claim 36, wherein each attachment mechanism comprises a projection that controls an angle of each respective arm relative to a longitudinal axis of the central hub when the respective arm is in its respective deployed position.

40. The apparatus of claim 36, wherein each attachment mechanism comprises a projection that controls an angle of each respective arm relative to the longitudinal axis of the central hub when the respective arm is in its respective undeployed position.

41. The apparatus of claim 30, wherein each of the plurality of arms flare outward from the longitudinal axis of the central hub at an angle of three to ten degrees when the apparatus is upright but not deployed in water.

42. The apparatus of claim 30, wherein a mating interface between each of the plurality of arms and the central hub controls an angle of each respective arm relative to a longitudinal axis of the central hub when the respective arm is in its respective deployed position.

43. The apparatus of claim 30, wherein either the apparatus comprises a weight affixed to the central hub or the central hub is negatively buoyant such that the entire apparatus is either neutrally buoyant or negatively buoyant.
